(19) United States
(12) Patent Application Publication
(10) Pub. No.: US 2004/0080212 A1
(43) Pub. Date: Apr. 29, 2004

(54) Dual voltage power supply for a controlling current consumption of a controller during sleep mode

(75) Inventors: Joerg Becker, Auburn Hills, MI (US); Mauricio Eduardo Hernandez-Distancia, Lake Orion, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/281,815

(22) Filed: Oct. 28, 2002

(51) Int. Cl. H02J 3/00

(52) U.S. Cl. 307/10.1; 307/80

(57) ABSTRACT

A power control arrangement for a controller provides a first voltage level so that the controller operates in a first mode and a second voltage level for operating in a second, sleep mode. In the case where the power supply is provided on a vehicle, the first voltage supply (24) draws power from a vehicle power supply (26). A second voltage supply (30) draws power from a vehicle battery (28). The second voltage supply provides a lower voltage so that the controller (22) operates in a sleep mode and draws minimal current. The inventive arrangement is particularly well suited for powering a controller that provides a real time clock function during a sleep mode.

### BACKGROUND OF THE INVENTION

This invention generally relates to power consumption control of microprocessors that provide a reduced level of operation during a sleep mode. More particularly, this invention relates to a multiple power supply arrangement for accommodating different levels of current consumption in such a controller.

A variety of electronics are incorporated onto modem day vehicles. The power provided to such electronics is drawn from the vehicle power system (i.e., the battery, alternator or both). While the vehicle is running, power consumption of the various devices typically is no problem. With the increasing number of electronics on a vehicle, it sometimes becomes challenging to maintain power consumption within desired limits. Even more challenging, however, is providing power to onboard electronics that still require some power even when the vehicle ignition is turned off.

When the vehicle ignition is turned off, any power consumption by electronics onboard the vehicle will tend to drain the battery. Minimizing power consumption when the vehicle is off, therefore, is mandatory. Many if not most onboard components and systems can be completely powered off when the vehicle ignition is turned off. Some components, however, require some operation even if those components operate in a sleep mode. For such components, a power supply strategy is required that provides adequate power within desired limits, yet still provides the ability for the electronics to operate as needed when the vehicle ignition is turned off.

This invention addresses the need for providing adequate power to at least one controller having reduced operation in a sleep mode.

### SUMMARY OF THE INVENTION

In general terms, this invention is a power supply arrangement for providing a controlled voltage to a controller when the controller operates in a sleep mode.

One example system designed according to this invention includes a controller that provides a plurality of functions in a full operation mode and at least one function when the controller is in a sleep mode. A first voltage supply provides power to the controller during the normal operation mode. A second voltage supply provides a reduced amount of power to the controller during the sleep mode so that the controller can perform the function required during the sleep mode.

In one example, the first voltage supply derives power from the vehicle power system (i.e., the alternator, battery or both) while the vehicle ignition is turned on. The second voltage supply derives power from the vehicle battery when the ignition is turned off.

Advantageously, the inventive arrangement provides a continuous power supply to the controller so that the controller operates as desired during sleep mode or full operation mode.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a system designed according to this invention.

FIG. 2 schematically illustrates, in somewhat more detail, one example implementation of a system designed according to this invention.

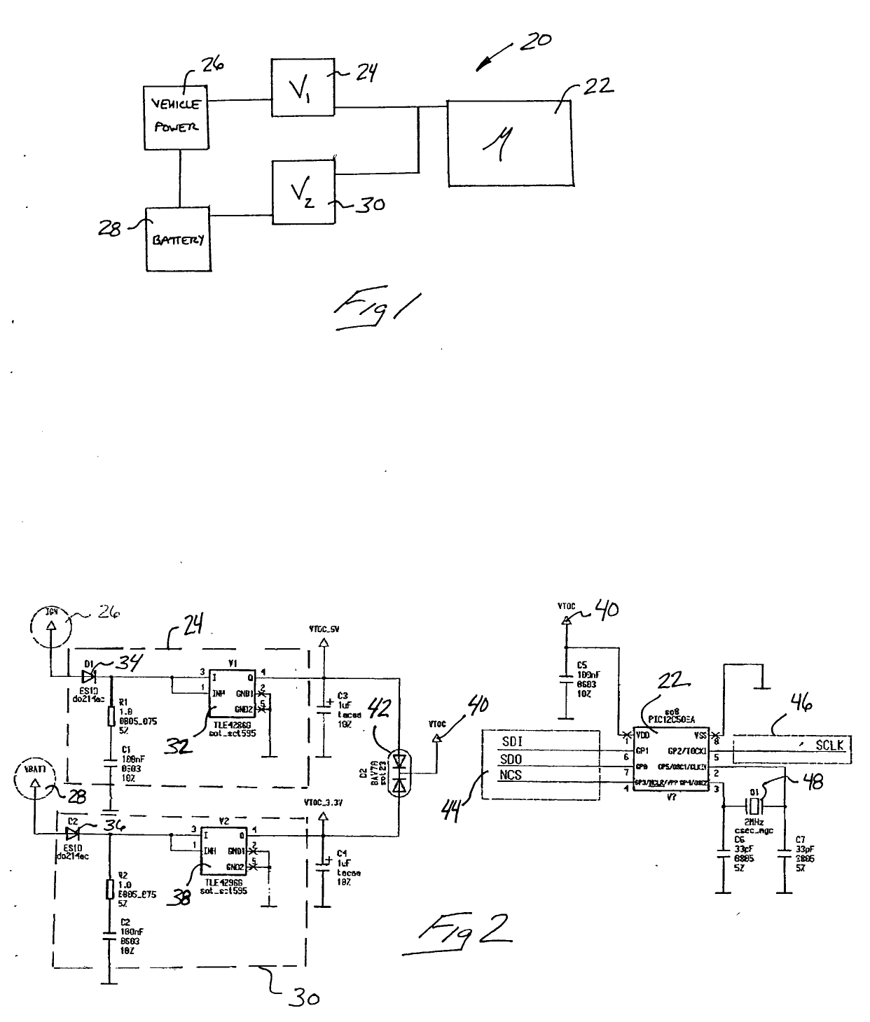

### DETAILED DESCRIPTION OF THE PREFERRED EMBODIMENTS

A vehicle power system 20 provides power to a controller 22 in at least two modes. The controller 22 provides a plurality of functions for communicating with or controlling a plurality of other components supported on a vehicle. In one example, the controller 22 is a part of an engine controller.

A first voltage supply 24 provides power to the controller 22 to operate in a normal operating mode. During the normal operating mode, the controller 22 provides a plurality of functions according to the programming of the controller to meet the needs of a particular situation. The voltage supply 24 in one example provides a five volt power level to the controller 22.

The voltage supply 24 derives power from the vehicle power system 26. Conventional alternator arrangements provide electrical power to a variety of components on a vehicle when the engine is running (i.e., the ignition is turned on). A conventional battery 28 is associated with the vehicle power supply 26 to provide power. The battery 28 cooperates with a conventional alternator as known to provide electrical power as needed during vehicle operation.

A second voltage supply 30 provides a second level of power to the controller 22 during a sleep mode. The voltage supply 30 is particularly useful when the vehicle ignition is turned off. In one example, the voltage supply 30 provides a 3.3 volt power level to the controller 22. The voltage supply 30 derives power directly from the vehicle battery 28. The voltage supply 30 minimizes the current draw by the controller 22 so that the battery 28 is not drained while the controller 22 operates in sleep mode. In one example, the controller 22 draws a current that is below 600 microamperes to avoid taxing or draining the battery 28.

Referring to FIG. 2, one example implementation of this invention includes a voltage regulator 32 within the first voltage supply 24. A rectifier 34 provides DC power to the voltage regulator 32 and ultimately to the controller 22. The rectifier 34 rectifies alternating current provided by the vehicle power supply 26. In one example, the voltage supply 24 provides a 5 volt output to the controller 22.

The second voltage supply 30 includes a rectifier 36 and voltage regulator 38. In one example, the voltage regulator 38 is configured so that the output power to the controller 22 is at a level of approximately 3.3 volts. The second power supply 30 preferably is always connected with a vehicle battery 28 so that whenever the vehicle ignition is turned off the voltage output available from the second voltage supply 30 is instantaneously and automatically provided to the controller 22.

The output at 40 from the two voltage supplies 24 and 30 operates to power the controller 22. The output at 40 always has some voltage; either 5 volts from the example first voltage supply 24 or 3.3 volts from the example second voltage supply 30. Of course, other voltage levels are within the scope of this invention, those levels are used for the particular illustrated example.

A decoupling diode arrangement 42 separates the two voltage supplies 24 and 30.

The controller 22 in the illustrated example provides multiple functions during a normal operating mode where the first voltage supply 24 provides the power to the controller 22. In the illustrated example, communication functions 44 and a clock function 46 are provided during normal operating conditions. When the vehicle ignition is turned off, the controller 22 enters a sleep mode where a reduced number of functions are performed by the controller 22. In the illustrated example, only the clock function 46 is provided by the controller 22 in the sleep mode. On oscillator 48 provides the clock function. The lower voltage provided by the second voltage supply 30 allows the oscillator 48 to operate at a high enough frequency to provide the necessary timing and resolution for the clock function 46 provided by the controller 22. The illustrated example, operating at a voltage of 3.3 volts, provides for less than 600 microamperes of current to be drawn by the controller 22 during the sleep mode.

The inventive arrangement provide a reliable and economical approach to providing different power levels to a controller so that the controller may absorb different amounts of power during a normal operating mode and a sleep mode, respectively. The inventive arrangement eliminates the need for level shifters and avoids back driving. Moreover, the inventive arrangement allows for higher clock rates than otherwise would be provided which otherwise caused higher current consumption.

Although the example implementation of this invention has been described in relation to a controller onboard a vehicle, the invention is not necessarily so limited.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A power supply system, comprising:
a controller that operates in a first mode and in a second, sleep mode;
a first voltage supply that provides a first voltage level to power the controller; and
a second voltage supply that provides a second, lower voltage level to power the controller when the controller operates in the second mode.

2. The system of claim 1, wherein the controller and the voltage supplies are supported on a vehicle and wherein the first voltage supply provides the first voltage when the vehicle engine is running and the second voltage supply provides the second voltage when the vehicle engine is off.

3. The system of claim 2, wherein the vehicle includes a power supply that provides electrical power when the engine is running and wherein the first voltage supply is coupled with the vehicle power supply and wherein the second voltage supply is coupled with a battery on the vehicle.

4. The system of claim 2, wherein the first voltage level is 5 volts and the second voltage level is below 3.5 volts.

5. The system of claim 4, wherein the controller uses less than about 650 microamperes current in the second mode.

6. The system of claim 1, wherein the controller provides a plurality of functions in the first mode and provides only a clock function in the sleep mode.

7. The system of claim 1, including a single input coupling the controller to the first and second voltage supplies and wherein a decoupling device isolates the first voltage supply from the second voltage supply.

8. The system of claim 7, wherein the decoupling device comprises oppositely arranged diodes.

9. The system of claim 1, wherein the second voltage supply constantly provides the second voltage and wherein the first voltage is provided to the controller whenever the first voltage supply is activated and the second voltage is automatically provided to the controller whenever the first voltage supply is not activated.

10. A method of providing power to a controller on a vehicle, comprising the steps of:
(A) providing a first power level to the controller when the vehicle engine is running; and
(B) providing a second, lower power level to the controller when the vehicle engine is off.

11. The method of claim 10, wherein step (A) includes powering the controller through a first voltage supply that provides a first voltage to the controller.

12. The method of claim 11, including coupling the first voltage supply to a power supply on the vehicle that provides electrical power when the engine is running.

13. The method of claim 11, wherein step (B) includes powering the controller through a second voltage supply that is coupled to a vehicle battery.

14. The method of claim 10, including continuously providing the second power level to a power input to the controller and providing the first power level to the controller whenever the first power level is available.
